(19) United States
(12) Patent Application Publication
(10) Pub. No.: US 2007/0248122 A1
(43) Pub. Date: Oct. 25, 2007

(54) Methods and systems relating to distributed time markers

(76) Inventor: Bruce Hamilton, Santa Clara, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/406,227

(22) Filed: Apr. 19, 2006

(51) Int. Cl. H04J 3/06; H04L 12/26

(52) U.S. Cl. 370/503; 370/241

(57) ABSTRACT

Methods and devices for coordinating and displaying electronic signals are disclosed. For example, an exemplary apparatus configured a particular system can include a local timing device capable of receiving external real-time clock signals from a first time source, the timing device being capable of maintaining a synchronized local real-time clock based on the received external real-time clock signals, instrumentation configured to detect and capture one or more local signals, an operator interface having at least a first display window capable of displaying an image of the one or more local signals, and a marking device coupled to the operator interface and configured to enable an operator to manually align one or more local markers to specific points relative to the displayed local signal image, wherein the marking device is further configured to derive a marking time for each local marker using the local real-time clock, wherein the marking device is further configured to receive remote marking information from a remote device, and wherein the apparatus is configured to provide at least one of the remote marking information and data derived from the remote marking information to the operator via the display window.

### BACKGROUND

Modern oscilloscopes often have what is known as a “marker” function, which can be useful for a number of things, such as giving a precise indication of an interval between two items of interest on an oscilloscope display. For example, often an electrical signal will consist of a “burst” of pulses, and an engineer examining the pulses will desire to know the duration of each pulse as well as the duration of the entire burst of pulses. By using the appropriate oscilloscope controls, the engineer can evoke two markers, align the first marker with the start of a particular pulse and align the second marker with the end of the pulse. As the engineer adjusts the alignment of the second marker, the oscilloscope can automatically display the time difference between the two pulses until both markers are appropriately set and the difference of time can be noted. Time measurement of the entire burst can be similarly made.

Unfortunately, this process has its limits, especially when an operator desires to precisely determine the time difference between two signals that are separated by large distances. This is due to the inherent limitations as to the lengths of oscilloscope probes (typically being no more that a few meters), as well as the problem of synchronizing different oscilloscopes given that the necessary synchronization technology is still in its infancy. Accordingly, new technology related to the capture and display of analog and digital signals is desirable.

### SUMMARY

In a first embodiment, an apparatus configured to monitor and/or test one or more devices or systems includes a local timing device capable of receiving external real-time clock signals from a first time source, the timing device being capable of maintaining a synchronized local real-time clock based on the received external real-time clock signals, instrumentation configured to detect and capture one or more local signals from a local tested device, wherein the one or more local signals start at a first time and have a first duration, an operator interface coupled to the instrumentation having at least a first display window capable of displaying an image of the one or more local signals, and a marking device coupled to the operator interface and configured to enable an operator to manually align one or more local markers to specific points relative to the displayed local signal image using the display window, wherein the marking device is further configured to derive a marking time for each local marker using the local real-time clock, wherein the marking device is further configured to receive remote marking information from a remote device, the remote device having its own separate instrumentation and its own marking device capable of deriving a marking time for a number of remote markers using a remote real-time clock also synchronized to the first time source such that the local real-time clock and the remote real-time clock are synchronized to an appreciable precision, and wherein the apparatus is configured to provide at least one of the remote marking information and data derived from the remote marking information to the operator via the display window.

In a second embodiment, an apparatus configured to monitor and/or test one or more devices or systems includes a marking means for generating local marking information for a locally measured signal, the marking means also for receiving remote marking information derived from a remote device, wherein the local marking information includes data indicating a first locally-generated marker and local time information indicating a locally derived time for the first locally-generated marker, wherein the remote marking information includes data indicating a first remotely-generated marker and remote time information indicating a remote derived time for the first remotely-generated marker, and wherein the local time information and the remote time information are derived from separate respective synchronized time clocks, and a display capable of displaying a graphic representation of the locally measured signal as well as an indication as to the time difference of the local and remote markers.

In a third embodiment, a method for monitoring and/or testing a first system using a set of distinct and independent electronic instruments with each instrument monitoring a different portion of the first system includes synchronizing a local real-time clock residing in a local instrument and a remote real-time clock residing in a remote instrument using a common network, the local and remote instruments being part of the set of distinct and independent electronic instruments, monitoring a first local signal generated by the first system by the local electronic instrument, generating a first local time marker related to the first local signal by an operator using the local electronic instrument, receiving, by the local electronic instrument and from the remote electronic instrument, a first remote time marker related to a first remote signal, and displaying a time difference indication of the first local marker and the first remote marker using a dedicated display incorporated into the local electronic instrument.

### DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 depicts a communications network in concert with an exemplary real-time testing system;

FIG. 2 depicts a block diagram of an exemplary test instrument;

FIG. 3 is a first exemplary display screen with embedded controls useful for generating local markers and importing remote markers;

FIG. 4 is a second exemplary display screen with embedded controls useful for capturing and manipulating local and remote time markers;

FIG. 5 depicts the second exemplary display screen of FIG. 4 modified to display remotely capture waveforms as well as remote time markers;

FIG. 6 depicts the exemplary display screen of FIG. 5 manipulated to show independent amplitude and time scaling between remotely and locally captured data;

FIG. 7 depicts the exemplary display screen of FIG. 5 further manipulated to show independent amplitude and time scaling between multiple remotely and locally captured data;

FIG. 8 depicts the exemplary display screen of FIG. 5 further manipulated to show independent amplitude and time scaling between one remote and multiple locally captured data; and

FIG. 9 is a block diagram outlining various exemplary operations directed to the generation and display of local time markers as well as the generation, importation and display of remote time markers.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

For the purposes of clarity and simplicity, the following disclosure is generally directed to systems employing oscilloscopes. However, as will be apparent to one of ordinary skill in the art while reading the following disclosure, the concepts discussed below can be equally applied to other test and measurement devices, such as logic analyzers, logic probes, spectrum analyzers, instruments directed to time-domain reflectrometry, remote data sensors, data bus analyzers, various specialty equipment and so on.

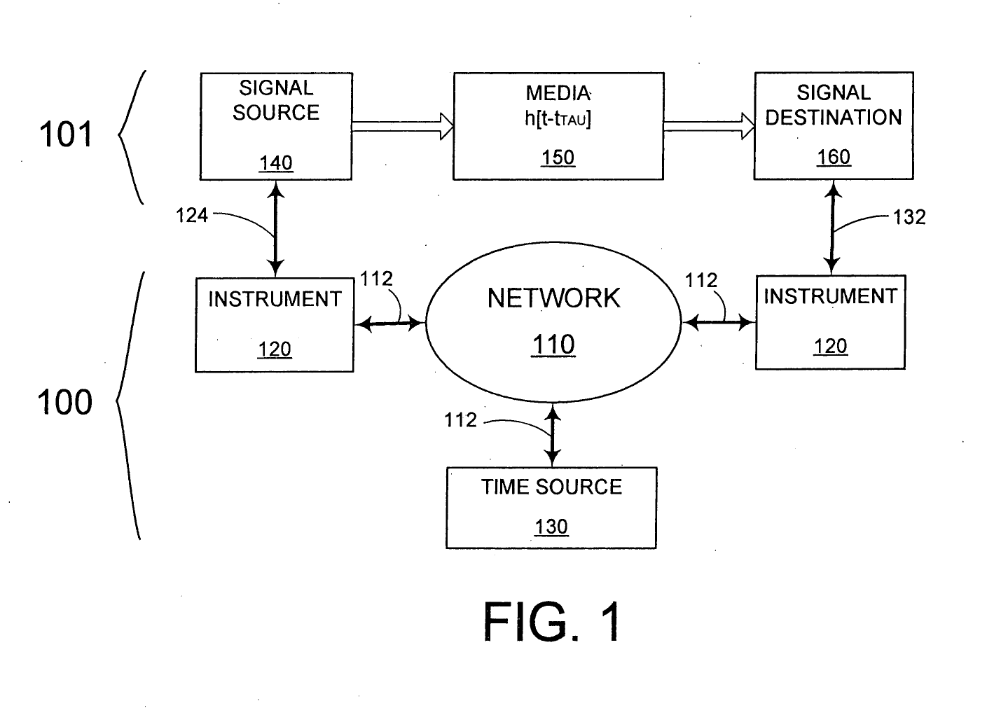

FIG. 1 depicts an exemplary testing system 100 used in concert with a tested system 101, which for the present example is a communication system having a signal source 140 and signal destination 160 with some intermediate transmission media 150 having an inherent impulse response h[t] and delay t_{TAU}. The exemplary testing system 100 consists of two instruments 120 (e.g., oscilloscopes) and a precision time source 130 coupled to a common network 110 via links 112.

In operation, the instruments 120 can be first synchronized to time source 130 such that each instrument 120 will have an internal timing device/clock that reflects (within an appreciable amount of precision) the same time as the time source 130. An example of such a synchronization technology can be found in the IEEE 1588 standard for “A Precision Clock Synchronization Protocol for Networked Measurement and Control Systems” (2002). However, the particular approach used for clock synchronization between various remotely-placed instruments can change from embodiment to embodiment without departing from the spirit and scope of the disclosed methods and systems.

As discussed above, the exemplary instruments 120 are digital oscilloscopes having a number of known/conventional functions, such as the ability to capture and display various analog and digital signals. Additional conventional function of the exemplary oscilloscopes can include the placement of markers relative to various displayed waveform features (e.g., the rising and falling edges of pulses), which can also automatically provide some form of numeric display indicating the time difference(s) between various markers.

However, in contrast to a typically/conventional oscilloscope, an oscilloscope of the present disclosure can associate each marker that an operator evokes with an “absolute time” reference using its internal synchronized time clock. Each absolute time reference, in turn, can be used to produce time difference values between markers.

In addition to the generation and placement of time markers, the oscilloscopes of the present disclosure can also import and/or export information about various markers generated using remotely place oscilloscopes. Such information can include some form of ID (e.g., a network address coupled with a marker number) as well as a respective synchronized absolute time value. Assuming that a particular exported marker is imported by a synchronized oscilloscope, the exported/imported marker can be compared to locally produced markers to produce meaningful information.

For example, an operator using a first exemplary oscilloscope can import a particular marker (with respective synchronized time value) derived using a second exemplary oscilloscope 50 yards away using an IEEE1588-compatible Ethernet communication system. Similarly, the same operator could import another particular marker (with respective synchronized time value) derived from yet another oscilloscope 50 miles away via the internet and using another synchronization technology. Once the various markers are imported, the imported markers can be referenced and their values displayed. Additionally, the differences between various locally derived markers and various imported markers can also be displayed and meaningfully interpreted/reviewed as the differences would be accurate to an appreciable precision. Other information, such as “screen shots” of oscilloscope waveforms, especially screen shots for which imported markers are correlated, can also optionally be imported and displayed.

In various embodiments, it should be appreciated that there can be circumstances where using separate operators to manipulate each oscilloscope/instrument may be problematic. Accordingly, in various embodiments the exemplary instruments can be specially configured such that a single operator using a display and/or controls of a single exemplary instrument can remotely perform data capture functions, such as adjusting the gain and timescale of a remote oscilloscope, adjusting the oscilloscope's triggering, evoking and setting remote markers, and so on. Additional useful operations can further include the importation of remotely captured waveforms as well as the importation of marker information.

The exemplary network 110 is an IEEE 1588-compliant Ethernet-based network. However, in other embodiments the network 110 can be any viable combination of devices and systems capable of linking computer-based systems including a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

The various links 112 of the present embodiment are a combination of devices and software/firmware configured to couple computer-based systems to an IEEE 1588-compliant Ethernet-based network. However, it should be appreciated that, in differing embodiments, the links 112 can take the forms of Ethernet links, modems, networks interface card, serial buses, parallel busses, WAN or LAN interfaces, wireless or optical interfaces and the like as may be desired or otherwise dictated by design choice.

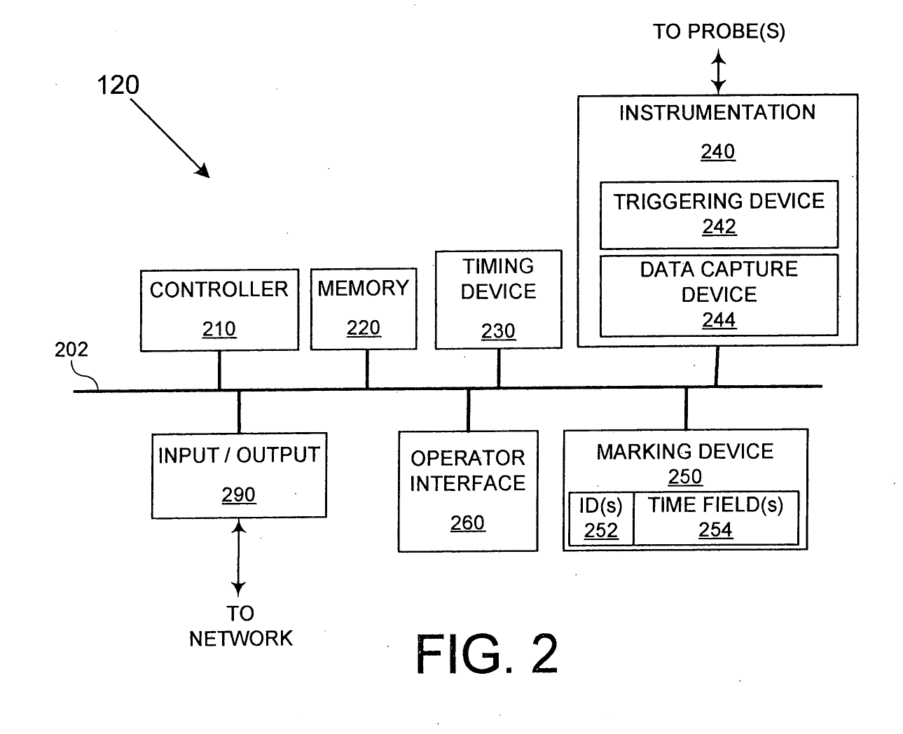

FIG. 2 depicts a block diagram of an exemplary test instrument 120, such as the test instruments discussed with respect to FIG. 1. As shown in FIG. 2, the test instrument 120 includes a controller 210, a memory 220, a timing device 230, a collection of instrumentation 240 containing a data capture device 242 and triggering device 244, a marking device 250, an operator interface 260 and an input/output device 290 capable of communicating with any number of networks. The marking device 250 contains a marker ID field 252 and a time field 254 to store information relating to each specific marker evoked by an operator.

Although the exemplary instrument 120 of FIG. 2 uses a bussed architecture, it should be appreciated that any other architecture may be used as is well known to those of ordinary skill in the art. For example, in various embodiments, the various components 210-290 can take the form of separate electronic components coupled together via a series of separate busses or a collection of dedicated logic arranged in a highly specialized architecture.

It also should be appreciated that some of the above-listed components can take the form of software/firmware routines residing in memory 220 and be capable of being executed by the controller 210, or even software/firmware routines residing in separate memories in separate servers/computers being executed by different controllers.

Returning to FIG. 2, operation starts as the instrument 120 is synchronized such that the timing device 230 contains a real-time clock that is synchronized to an external time source, such as a precision real-time clock specifically configured to provide a common time-base for a variety of different instruments. Synchronization with an external time source optionally can be established via the input/output device 290 and an external network, but the particular form of synchronization approach used can change from embodiment to embodiment as may be found advantageous.

Once the timing device 230 has established a synchronized real-time clock, an operator using the operator interface 260 can monitor any number of electronic signals by commanding the instrumentation 240 to capture various waveforms using the trigging device 242 and data capture device 244. Next, the captured waveforms can be displayed at the operator interface 260. Then, using the marking device 250 and timing device 230, the operator can evoke various markers and appropriately align the markers using graphic cues available at the operator interface 260. Marker information, e.g., an ID and respective absolute time reference, can be internally stored in the appropriate marker fields 252 and 254.

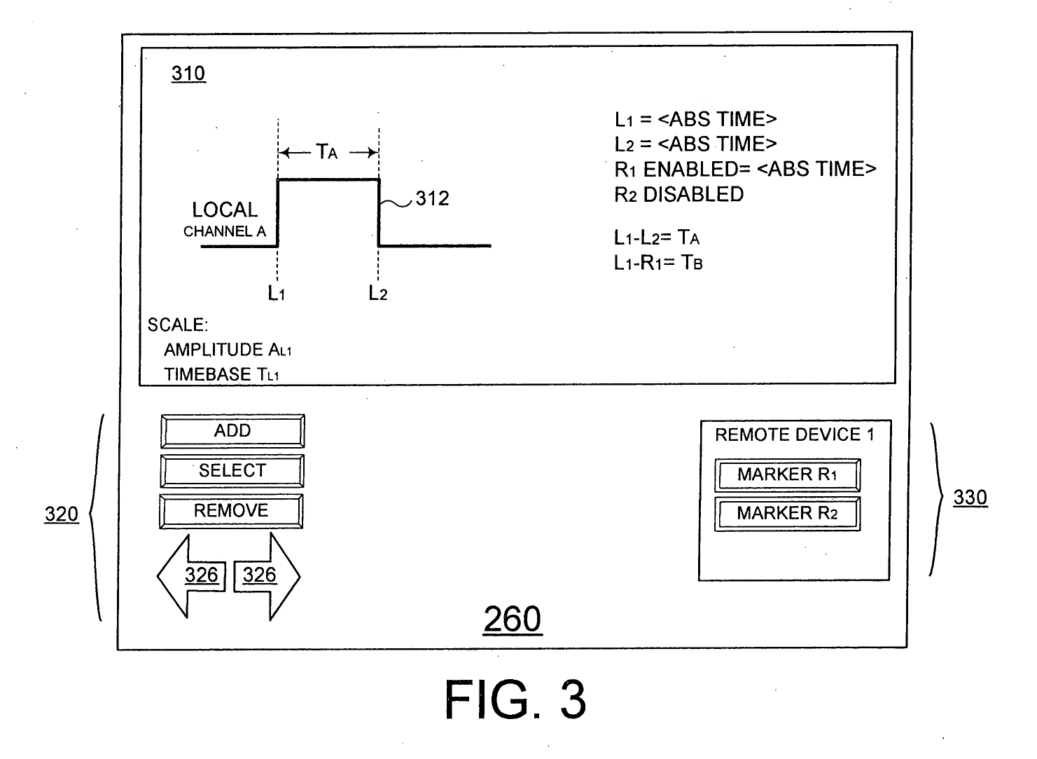

FIG. 3 depicts a first exemplary operator interface 260 (or a portion thereof) having a display screen 310 with embedded controls, including controls for capturing local signals (not shown for simplicity), a first set of virtual instruments 320 for evoking local time markers and a second set of virtual instruments 330 for importing remote time markers. Local markers can be evoked and manipulated using the “ADD”, “SELECT” and “REMOVE” buttons as well as the left/right arrows 326. Remote markers, which for the present example are derived independently of the operator interface 260, can be evoked by merely pressing either of the “REMOTE R₁” or “REMOTE R₂” button.

As shown on FIG. 3 an exemplary pulse waveform 312 is displayed based on a first amplitude scale A_{L1} and first timebase T_{L1}. The pulse 312 is shown as coming from “channel A” of a local oscilloscope (which often have two channels referred to as “A” and “B”). Local markers L₁ and L₂ are depicted as superimposed on the rising and falling edges of the pulse 312 with a relative time difference T_{A} being displayed in graphic form between L₁ and L₂. Absolute time is also available as a simple displayed value for each of L₁ and L₂.

In the present embodiment, remote marker R₁, which is presumably derived by a remote operator using a remote oscilloscope, is not displayed graphically but only in terms of a numeric, absolute time value. Remote marker R₂ is depicted as being disabled/not used. Absolute time for marker R₂ and the relative times between the local markers L₁ and L₂ and remote marker R₁ are also provided.

Returning to FIG. 2, in addition to importing remote marking information, the exemplary instrument 120 can also export marking information residing in the marking device 260 based upon commands received either remotely or via the operator interface 260. That is, the exemplary instrument 120 can play the role of a remote device to another instrument.

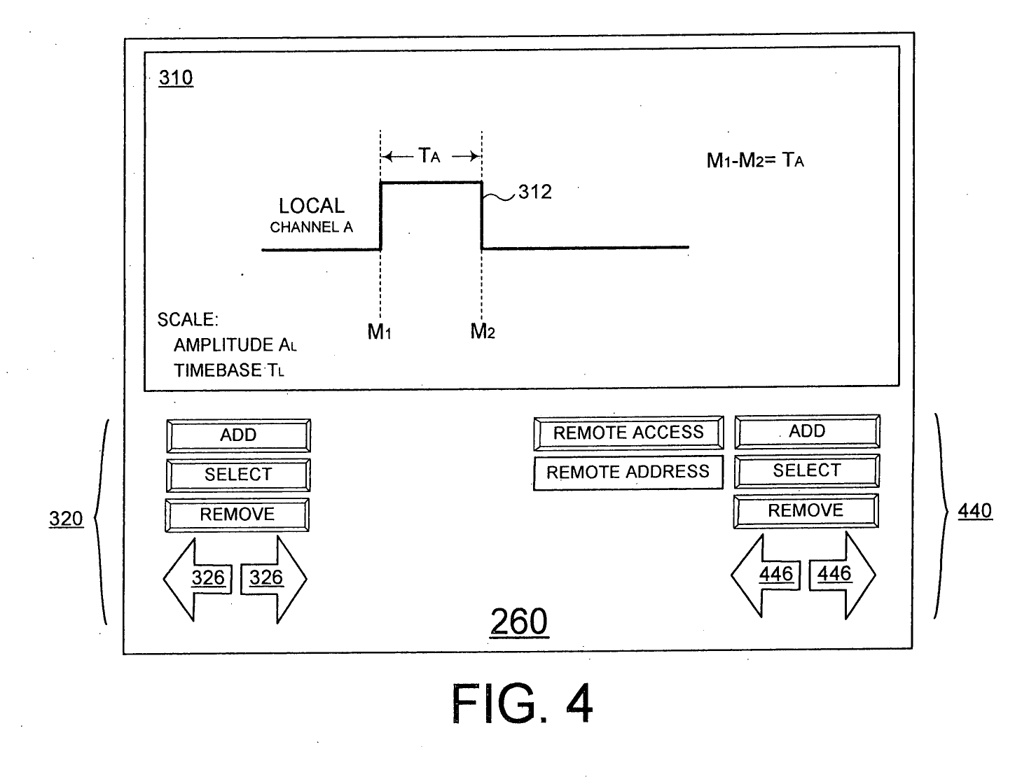

In still yet other embodiments, a particular instrument can be configured to manipulate remote marker information, as oppose to merely import remotely derived markers. For example, FIG. 4, which shows the operator interface 260 of FIG. 3 modified to include a series of remote marker controls 440, can be used to enable an operator to take control of a remotely located instrument identified by the “REMOTE ADDRESS” field by pressing the “REMOTE ACCESS” button. Once in control, the operator can evoke and manipulate remote markers using the “ADD”, “SELECT” and “REMOVE” buttons as well as the left/right arrows 446, with each marker being automatically imported for local display.

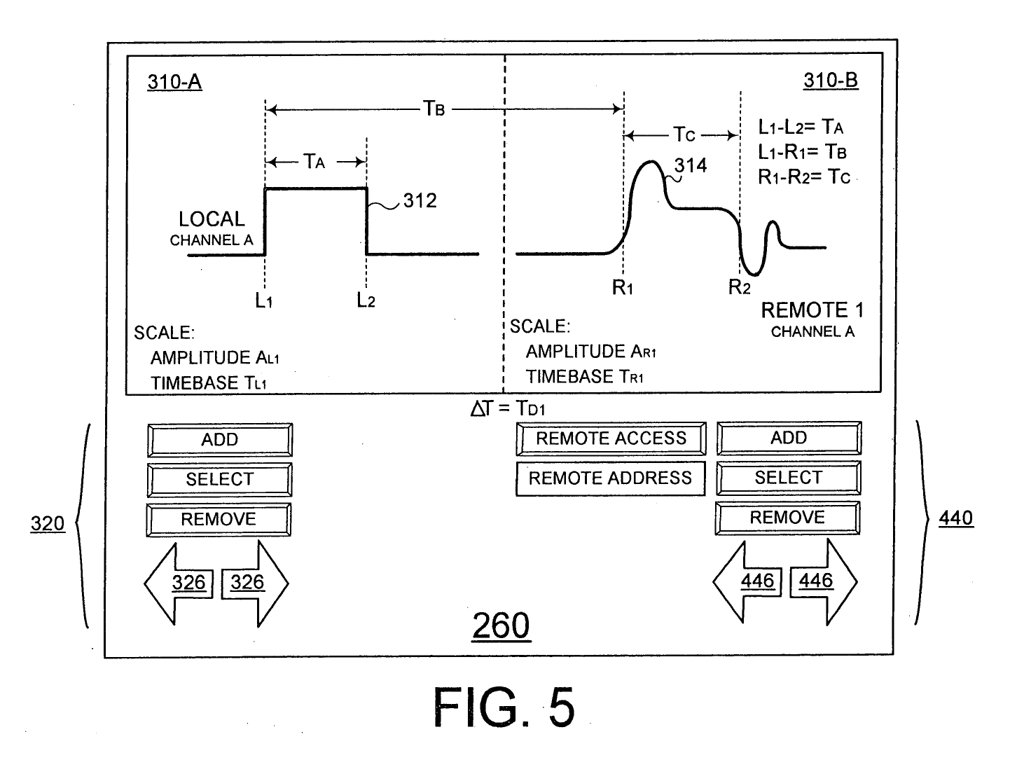

FIG. 5 shows yet another embodiment of the operator interface 260 of FIG. 2 where the display 310 is split into two portions: 310A and 310B. As shown in FIG. 5, locally derived information is displayed in display portion 310A and remotely derived information is displayed in display portion 310B.

For the purpose of the present example, local information is presumed to precede remote information, and so display portion 31 OA is ergonomically placed to the left of display portion 310B to resemble a conventional timeline. Display portion 310A is depicted as having a (optionally adjustable) time discontinuity of T_{D1} with respect to display portion 310B. Note that a left/right format can provide a better sense of time sequence than the typical up/down display of conventional oscilloscopes. While local information is depicted on the left and remote information on the right, it should be appreciated that, should remote information precede local information, such remote information can automatically be place to the left of the local information. Additionally, let/right sequence can alternatively be changed should the operator desire to intentionally make such a display change.

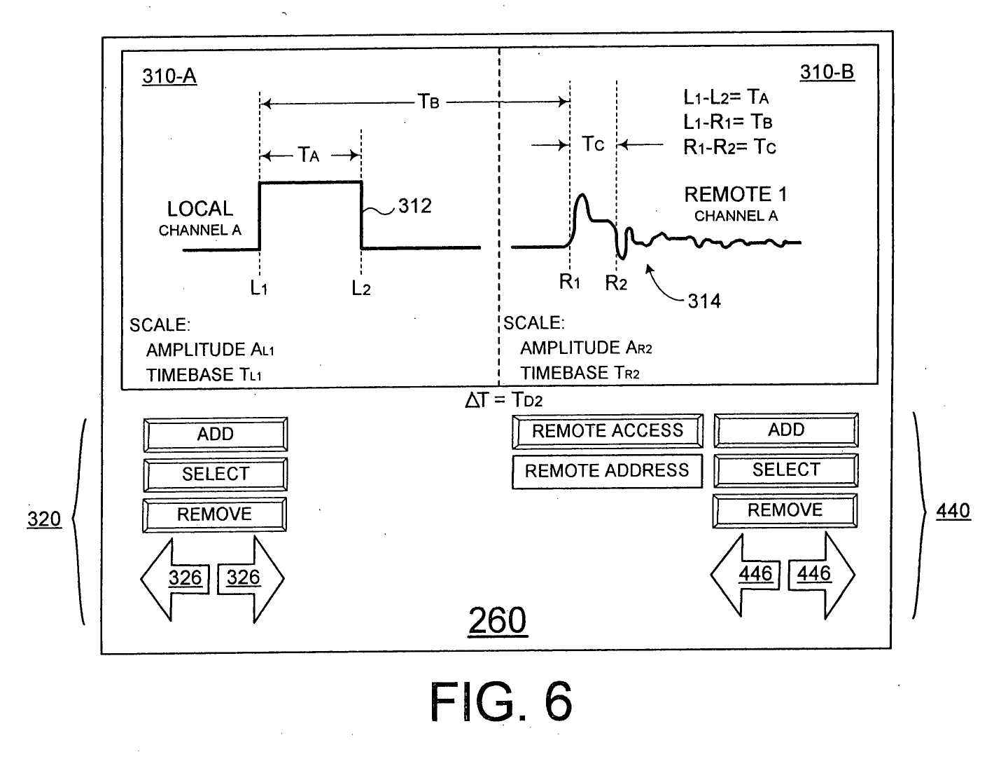

For the present example of FIG. 5, the necessary controls to manipulate remote amplitude A_{R1}, remote timebase T_{R1} and remote triggering are omitted for simplicity of display. Also note that remote and local amplitude and timebase information can be independently manipulated and displayed for the benefit of the operator. To further demonstrate this point, FIG. 6 is provided, which depicts a variation of the display of FIG. 5 where the timescale and amplitude of the remote display portion 310B have been changed independent of the timescale and amplitude of the local display portion 310A.

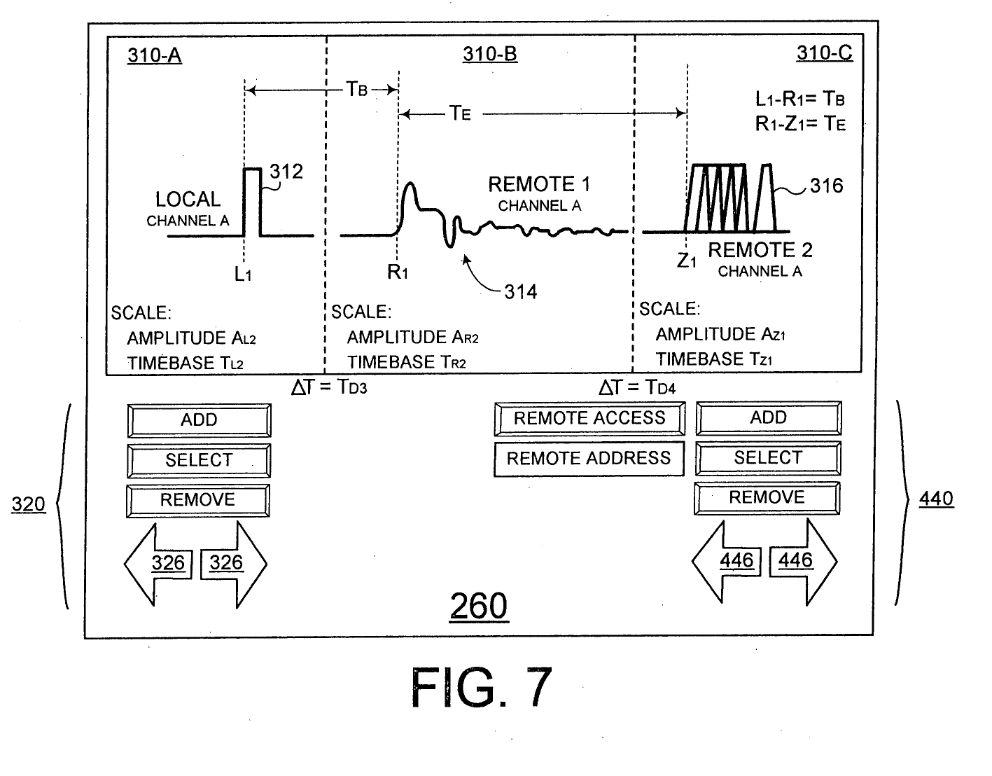

FIG. 7 depicts another variation of the display of FIG. 5 where the timescale and amplitude of the remote display portion 310A have been changed without affecting the waveform of display portion 310B, and a third display portion 310C is added to depict remotely captured waveforms and markers from a second remote instrument. As with the other display portions 310A and 310B, the amplitude A_{Z1} and timescale T_{Z1} attributes of display portion 310C can be independently set. Similarly, time discontinuity values T_{D3} and T_{D4} can be independently set in the same manner as the time discontinuity value T_{D1} of FIG. 5.

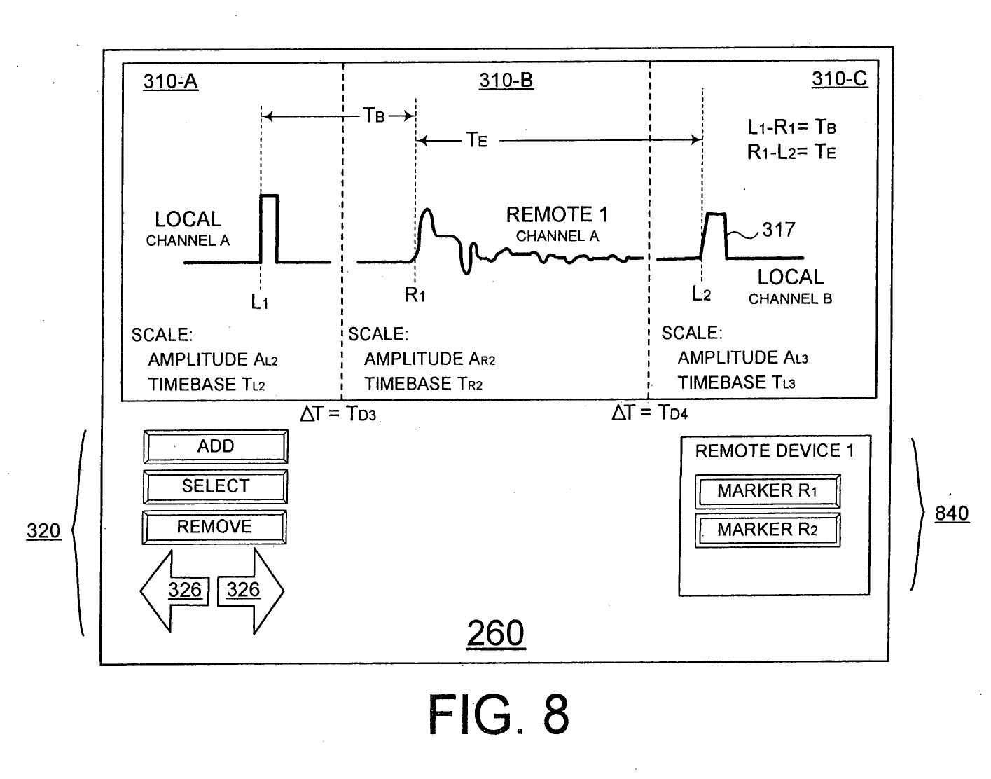

FIG. 8 depicts yet another variation of the display of FIG. 5 where the third display portion 310C is used to display a locally captured waveform (via channel B) of the same oscilloscope used to capture the waveform used for display portion 310A. FIG. 8 is used to demonstrate that the use and placement of display waveforms and marker data can vary in a versatile manner. That is, while the local waveforms 312 and 317 of display portions 310A and 310C are depicted as coming from two different A/B channels of the same oscilloscope, it should be appreciated that the same amplitude and timescale display versatility discussed using different oscilloscopes can be applied to the same oscilloscope. Still further, it should be appreciated that the same amplitude and timescale display versatility discussed using different oscilloscopes can be applied to the same channel of the same oscilloscope. That is, the present display portions 310A-310C can be used to display different portions of the same signal (with different amplitude and timebase scaling) derived from the same electrical node, but differing substantially in time.

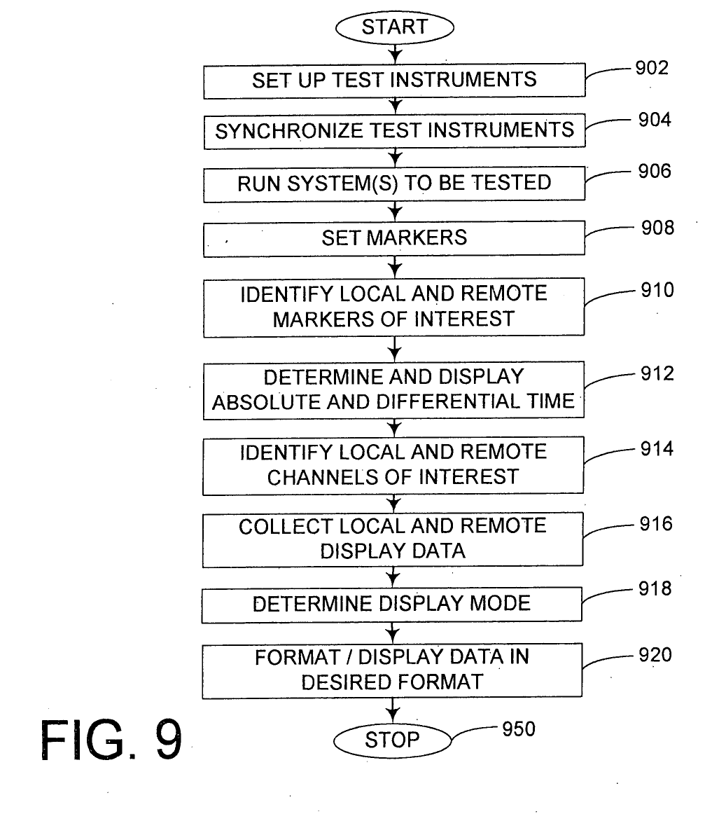

FIG. 9 is a block diagram outlining various exemplary operations directed to the capture and display of local and remotely captured data. The process starts in step 902 where a number of test instruments at various locations remote with respect to one another are set up. That is, each instrument is connected to nodes of interest, appropriately powered, appropriately connected to a network and so on. Next, in step 904, the test instruments of step 902 are synchronized using any of various known or later developed techniques. Then, in step 906, the various systems to be tested are put into whatever mode of use is to be tested. Control continues to step 908.

In step 908, various time markers at each instrument are manipulated and set. As discussed above, such markers can be set locally by independent operators, or alternatively set by a single operator using locally available controls that can be embedded into an instrument or into a separate computer-based device. Next, in step 910, a particular operator at a particular instrument can identify and import marking information of interest, or in contrast a particular operator at a particular instrument can export marking information of interest to an identified instrument. Control continues to step 912.

In step 912, local and remote marking information, including some form of ID and respective absolute time, can be displayed. Similarly, time differences between various markers, including between local and remote markers or between different remote markers derived from different remote instruments, also can be displayed. Control continues to step 914.

In step 914, various local and remote channels of interest can be identified. For example, an operator at a first oscilloscope can identify: (1) a local oscilloscope channel, and (2) a set of data lines monitored by a remotely located logic analyzer. Control continues to step 916.

In step 916, the desired local and remote data can be collected, which can involve certain data collection steps, such as setting triggers, setting allowable time windows or setting any other of the various known data collection prerequisites, as well as the actual export, transfer and reception of data. Control continues to step 918.

In step 918, a display mode for the data identified in step 914 is determined, which for the present circumstances can take a variety of forms, including those left/right formats discussed above. It can also include accounting for different amplitude scales, timebases, time discontinuity values, location of comments and text, sequence of waveforms and so on. Next, in step 920, the collected data is appropriately formatted and displayed according to the display modes of step 918. Control then continues to step 950 where the process stops.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods described above.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus configured to monitor and/or test one or more devices or systems, the apparatus comprising:
a local timing device capable of receiving external real-time clock signals from a first time source, the timing device being capable of maintaining a synchronized local real-time clock based on the received external real-time clock signals;
instrumentation configured to detect and capture one or more local signals from a local tested device, wherein the one or more local signals start at a first time and have a first duration;
an operator interface coupled to the instrumentation having at least a first display window capable of displaying an image of the one or more local signals; and
a marking device coupled to the operator interface and configured to enable an operator to manually align one or more local markers to specific points relative to the displayed local signal image using the display window, wherein the marking device is further configured to derive a marking time for each local marker using the local real-time clock;
wherein the marking device is further configured to receive remote marking information from a remote device, the remote device having its own separate instrumentation and its own marking device capable of deriving a marking time for a number of remote markers using a remote real-time clock also synchronized to the first time source such that the local real-time clock and the remote real-time clock are synchronized to an appreciable precision; and
wherein the apparatus is configured to provide at least one of the remote marking information and data derived from the remote marking information to the operator via the display window.

2. The apparatus of claim of claim 1, further comprising a common communications network capable of providing communication between the local timing device, the remote device and the first time source.

3. The apparatus of claim of claim 2, further comprising a first set of remote electronic systems interacting with the local timing device, wherein the first set of remote electronic systems includes the remote device and the first time source.

4. The apparatus of claim of claim I, wherein the apparatus is configured to provide a first indication of a time difference between at least one local marker and at least one remote marker.

5. The apparatus of claim of claim 4, wherein at least one remote marker is set by a second operator manipulating the remote device.

7. The apparatus of claim of claim 4, wherein the operator interface is further configured to receive remote graphic information relating to the graphic shape of a first remote waveform derived from the instrumentation of the remote device, and further configured to display the graphic shape of a first remote waveform.

8. The apparatus of claim of claim 7, wherein the first indication of time difference includes at least one local marker graphic and at least one remote marker graphic on the display window.

9. The apparatus of claim of claim 7, wherein the operator interface is further configured to display the local signal image and the graphic shape of the first remote waveform on the display window such that the two signals are separated along a left-right axis.

10. The apparatus of claim of claim 9, wherein the display can be separated into at least a first and second portion with the local signal image residing in the first display portion and the graphic shape of the first remote waveform residing in the second display portion.

11. The apparatus of claim of claim 10, wherein events in the first display portion are indicated as occurring prior in time to events in the second display portion.

12. The apparatus of claim of claim 11, wherein the first display portion and the second display portion have a time discontinuity between them.

13. The apparatus of claim of claim 11, wherein the first display portion and the second display portion have independent time bases.

14. The apparatus of claim of claim 11, wherein amplitude gain of the first display portion can be set independent of the amplitude gain of the second time base.

15. The apparatus of claim of claim 1, wherein the common communications network uses an IEEE 1588 protocol.

16. An apparatus configured to monitor and/or test one or more devices or systems, the apparatus comprising:
a marking means for generating local marking information for a locally measured signal, the marking means also for receiving remote marking information derived from a remote device, wherein the local marking information includes data indicating a first locally-generated marker and local time information indicating a locally derived time for the first locally-generated marker, wherein the remote marking information includes data indicating a first remotely-generated marker and remote time information indicating a remote derived time for the first remotely-generated marker, and wherein the local time information and the remote time information are derived from separate respective synchronized time clocks; and
a display capable of displaying a graphic representation of the locally measured signal as well as an indication as to the time difference of the local and remote markers.

17. A method for monitoring and/or testing a first system using a set of distinct and independent electronic instruments with each instrument monitoring a different portion of the first system, the method comprising:
synchronizing a local real-time clock residing in a local instrument and a remote real-time clock residing in a remote instrument using a common network, the local and remote instruments being part of the set of distinct and independent electronic instruments;
monitoring a first local signal generated by the first system by the local electronic instrument;
generating a first local time marker related to the first local signal by an operator using the local electronic instrument;
receiving, by the local electronic instrument and from the remote electronic instrument, a first remote time marker related to a first remote signal; and
displaying a time difference indication of the first local marker and the first remote marker using a dedicated display incorporated into the local electronic instrument.
